(19) United States
(12) Patent Application Publication
(10) Pub. No.: US 2014/0012859 A1
(43) Pub. Date: Jan. 9, 2014

(54) PERSONALIZED DYNAMIC CONTENT DELIVERY SYSTEM

(71) Applicants: J.D. Heilprin, New York, NY (US); Ernst Schoen-Rene, San Francisco, CA (US); Robert Manson, San Francisco, CA (US); Damian Hites, Oakland, CA (US); Kent Daniels, El Cerrito, CA (US)

(72) Inventors: J.D. Heilprin, New York, NY (US); Ernst Schoen-Rene, San Francisco, CA (US); Robert Manson, San Francisco, CA (US); Damian Hites, Oakland, CA (US); Kent Daniels, El Cerrito, CA (US)

(73) Assignee: AGOGO Amalgamated, Inc., Palo Alto, CA (US)

(21) Appl. No.: 13/541,051

(22) Filed: Jul. 3, 2012

(51) Int. Cl. G06F 17/30; G06F 15/16

(52) U.S. Cl. 707/748; 709/217; 707/758; 707/E17.014

(57) ABSTRACT

Methods and systems are disclosed for delivering content to users. In one embodiment, a computer system obtains text associated with a content item, where the text comprises: text from a transcript associated with a content item, when available; text from a web feed (e.g., an RSS feed, etc.) associated with the content item, when available; text from a webpage associated with the content item, when available; and text that is returned from a call to an application programming interface (API) of a provider of the content item, when available. The computer system then determines a set of entities based on the obtained text.

### TECHNICAL FIELD

Embodiments of the present disclosure relate to data processing, and more specifically, to delivering content to users.

### BACKGROUND

Increasingly users are consuming content (e.g., audio clips containing music, non-music audio clips, television broadcasts, webpages, text-based documents, video clips, etc.) on their mobile devices (e.g., smartphones, tablets, etc.). Locating content that is of interest, however, can be challenging, particularly for users who are mobile, and this difficulty may be exacerbated by small screens and lack of full-function keyboards that are typical of mobile devices.

### BRIEF DESCRIPTION OF THE DRAWINGS

Embodiments of the present disclosure will be understood more fully from the detailed description given below and from the accompanying drawings of various embodiments of the disclosure, which, however, should not be taken to limit the invention to the specific embodiments, but are for explanation and understanding only.

FIG. 1 illustrates an exemplary system architecture, in accordance with one embodiment of the present disclosure.

FIG. 2 is a block diagram of one embodiment of a content processing manager.

FIGS. 3A and 3B depict an embodiment of a data schema and an illustrative portion of a semantic network for a content catalog.

FIG. 4 depicts a flow diagram of one embodiment of a method for processing a content item.

FIG. 5 depicts a flow diagram of one embodiment of a method for obtaining metadata associated with a content item.

FIG. 6 depicts a flow diagram of one embodiment of a method for obtaining text associated with a content item.

FIG. 7 depicts a flow diagram of one embodiment of a method for obtaining a set of entities associated with a content item.

FIG. 8 depicts a flow diagram of one embodiment of a method for matching a set of entities against a content catalog.

FIG. 9 depicts a flow diagram of one embodiment of a method for obtaining a subset of a set of entities associated with a content item.

FIG. 10 depicts a flow diagram of one embodiment of a method for determining a relevance score for an entity with respect to a content item.

FIG. 11 depicts a flow diagram of one embodiment of a method for generating and updating a playlist.

FIG. 12 depicts a flow diagram of one embodiment of a method for presenting a playlist to a user and processing user input.

FIG. 13 depicts a block diagram of an illustrative computer system operating in accordance with embodiments of the disclosure.

### DETAILED DESCRIPTION

Methods and systems are disclosed for delivering customized playlists of content items (e.g., audio clips containing music, non-music audio clips, webpages, text-based documents, video clips, etc.) to users' client devices (e.g., smartphones, tablets, notebook computers, personal computers, etc.). In one embodiment, the playlist may contain links to content items from a variety of sources (e.g., National Public Radio, The Wall Street Journal, etc.) and may be intelligently selected for the user based on a variety of criteria, including: a user profile (e.g., a profile that a user chooses from a set of possible profiles, a profile that a user builds, a profile that is instantiated with a user's answers to questions such as “What is your favorite genre of music?”, etc.); a user's calendar or schedule that stores meetings, appointments, travel plans, etc.; a user's current geo-location (as inferred from the user's client device); one or more “home base” geo-locations of a user (e.g., a user who has an apartment in New York and a house in Los Angeles would have two such home base geo-locations); a user's current speed (as inferred from the user's client device); the current time at the user's geo-location; the current traffic in the vicinity of the user's geo-location; the current weather at the user's geo-location; past user behavior (e.g., previous content item selections, historical driving information, past entries in a calendar or schedule, etc.); and input from an administrator or curator. In one embodiment, a playlist may also be augmented with content items that are related to items previously selected by the user, or are related to an entity (e.g., a proper noun such as San Francisco, Mayor Ed Lee, Agogo Amalgamated, etc.) or a topic (e.g., news, politics, sports, etc.) specified by the user.

In one embodiment, a server may determine related items based on relevance scores that the server assigns to entity-content item pairs, affinity scores that the server assigns to entity-entity pairs (e.g., “New York” and “Broadway” have a higher degree of correlation than “New York” and “Golden Gate Bridge”, etc.), and semantic relationships between entities (e.g., Tom Brady is a quarterback on the New England Patriots, etc.). The server may identify related items itself or use one or more application programming interfaces (APIs) to identify related items (e.g., an iTunes API that identifies tracks related to another track, an Amazon.com API that identifies books associated with Abraham Lincoln, etc.).

In one embodiment, the server may also suggest actions to the user based on their selection of content items. For example, when a user has selected an interview with the author Stephen King about his latest book, the user might receive a suggested action to purchase the book at Amazon.com, without having to proactively visit the Amazon.com website, locate the book, add the book to the cart, purchase it, and, if an audio version, be provided access to the book directly.

Embodiments of the present disclosure thus enable a user to receive customized playlists containing content items that are likely of interest to the user, as well as suggested actions that are pertinent and convenient for the user to perform. In one embodiment, automated speech recognition (ASR) and text-to-speech (TTS) capabilities are employed to deliver text content in audio form and process spoken user commands, thereby enabling a user who is driving a car to use the system in a safe and convenient fashion.

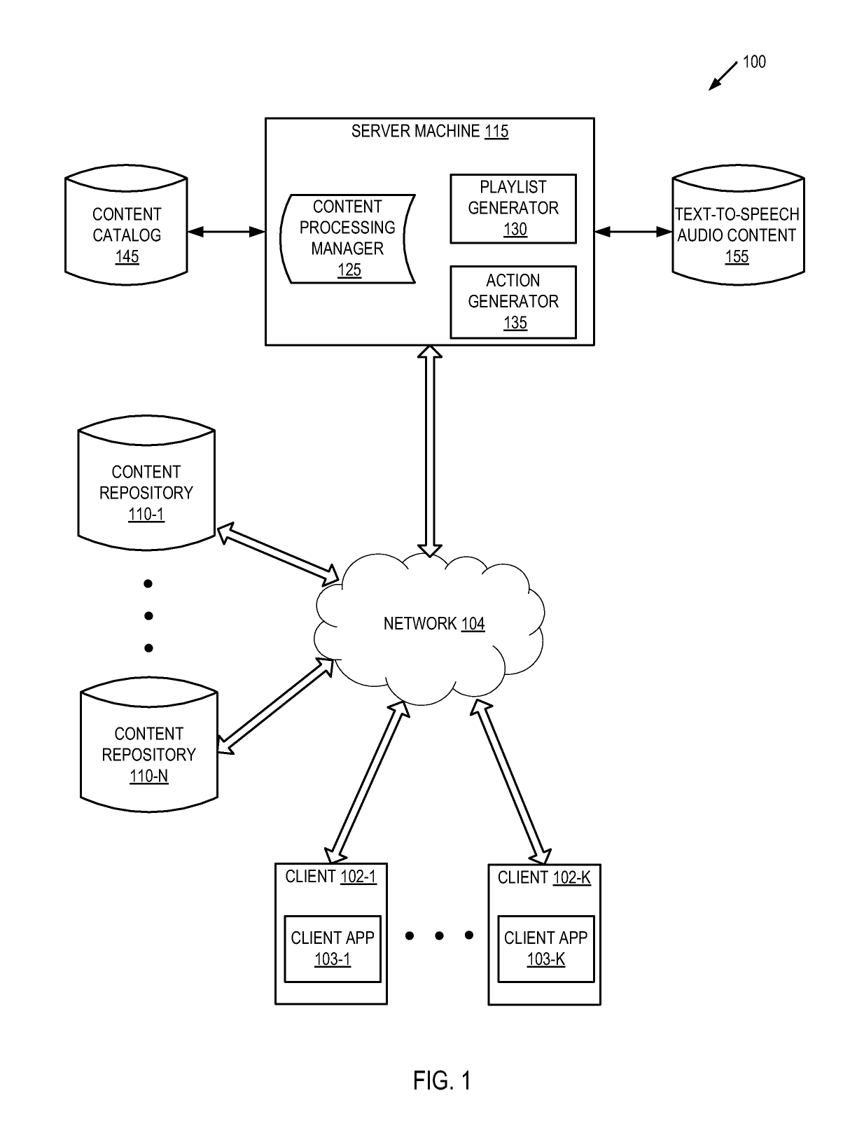

FIG. 1 illustrates an example system architecture 100, in accordance with one embodiment of the present disclosure. The system architecture 100 includes a server machine 115, a content catalog 145, a text-to-speech (TTS) audio content data store 155, content repositories 110-1 through 110-N, where N is a positive integer, and client machines 102-1 through 102-K, wherein K is a positive integer, connected to a network 104. Network 104 may be a public network (e.g., the Internet), a private network (e.g., a local area network (LAN) or wide area network (WAN)), or a combination thereof.

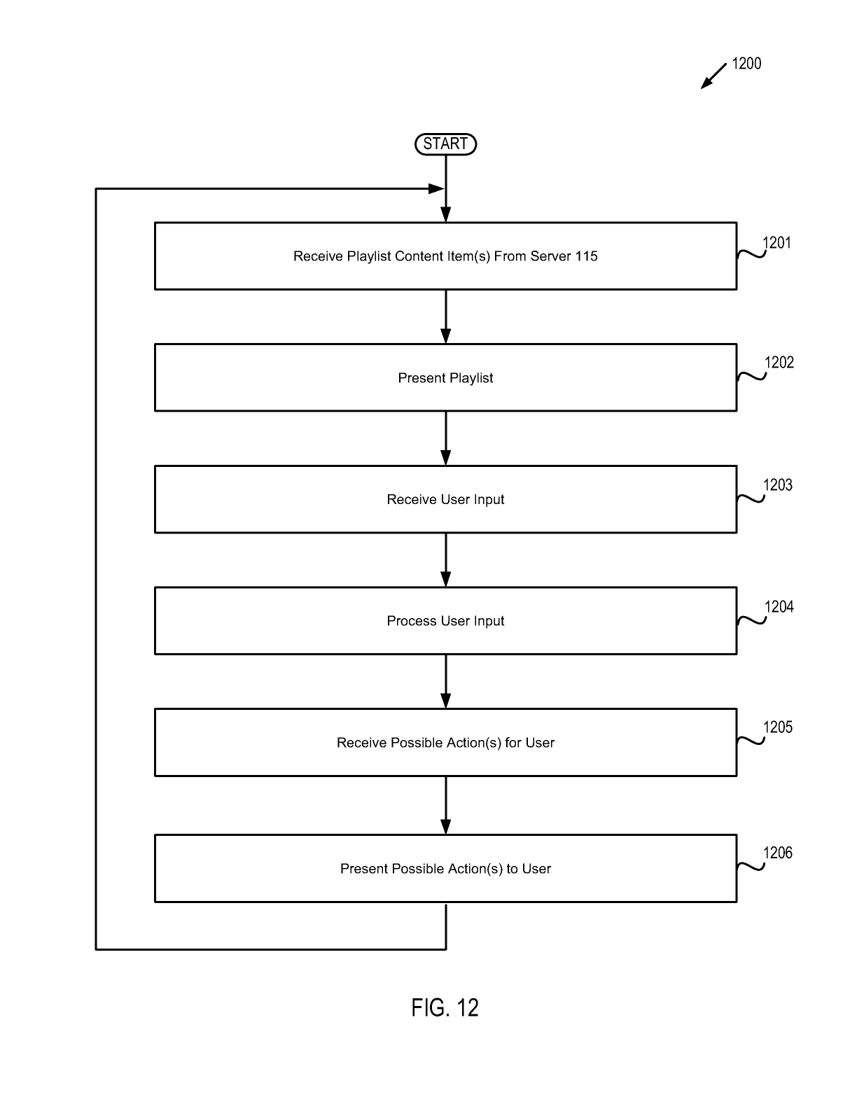

The client machines 102-1 through 102-K may be wireless terminals (e.g., smartphones, etc.), personal computers (PC), laptops, tablet computers, or any other computing or communication devices, and may run an operating system (OS) that manages hardware and software. Each client machine 102-j (where j is an integer between 1 and K inclusive) executes a client application 103-j that: receives from server machine 115 a playlist comprising links to content items stored in content repositories 110-1 through 110-N; presents the playlist to a user; receives input from the user (e.g., for selecting an item in the playlist to play, for requesting content items related to a particular entity or topic, etc.); transmits the user input to server machine 115; receives possible actions for the user from server machine 115; and presents the possible actions to the user. In addition, each client machine 102-j may be capable of determining its geo-location and reporting geo-location to server machine 115. An embodiment of a method by which client application 103-j may operate is described in detail below with respect to FIG. 12.

Server machine 115 may be a rackmount server, a router computer, a personal computer, a portable digital assistant, a mobile phone, a laptop computer, a tablet computer, a camera, a video camera, a netbook, a desktop computer, a media center, or any combination of the above. Server machine 115 may include a content processing manager 125 and a playlist generator 130. In some embodiments server machine 115 may comprise a plurality of machines (e.g., a plurality of blade servers, etc.) rather than a single machine, and content processing manager 125 and playlist generator 130 may run on different machines.

Each content repository 110-j (where j is an integer between 1 and N inclusive) comprises a persistent storage that is capable of storing content items (e.g., audio clips containing music, non-music audio clips, webpages, text-based documents, video clips, etc.) and, optionally, metadata associated with the content items, and is affiliated with a particular provider or publisher of the content items (e.g., National Public Radio, the Associated Press, etc.). In some embodiments, server machine 115 has access to content repository 110-j. In other embodiment, server machine 115 does not have access to content repository and can instead use one or more application programming interfaces (APIs) of a server associated with content repository 110-j to obtain metadata for a content item, identify content items that are related to another content item, and perform other such types of functions. Content repository 110-j may be a network-attached server, a relational database, an object-oriented database, etc.

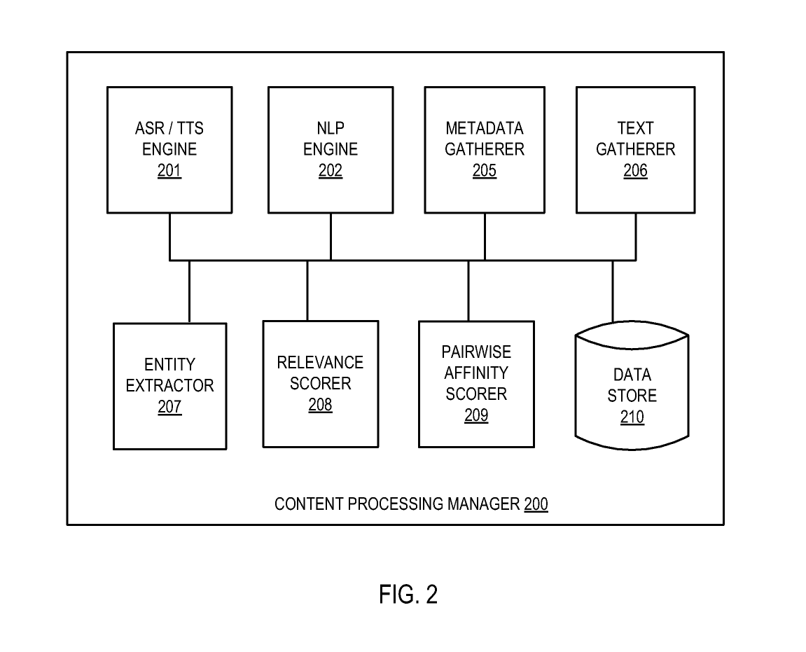

In accordance with some embodiments, content processing manager 125 is capable of gathering text and metadata associated with content items, performing automated speech recognition (ASR) to obtain text from audio content items, performing text-to-speech (TTS) conversion to obtain audio from textual content items, performing natural language processing (NLP) to identify noun groups in text, extracting entities from metadata and from noun groups identified in text, determining relevance scores for entities with respect to content items, determining pairwise affinity scores for pairs of entities, storing information about content items, entities, and scores in content catalog 145 and storing TTS audio files in TTS audio content data store 155. An embodiment of content processing manager 125 is described in detail below and with respect to FIG. 2.

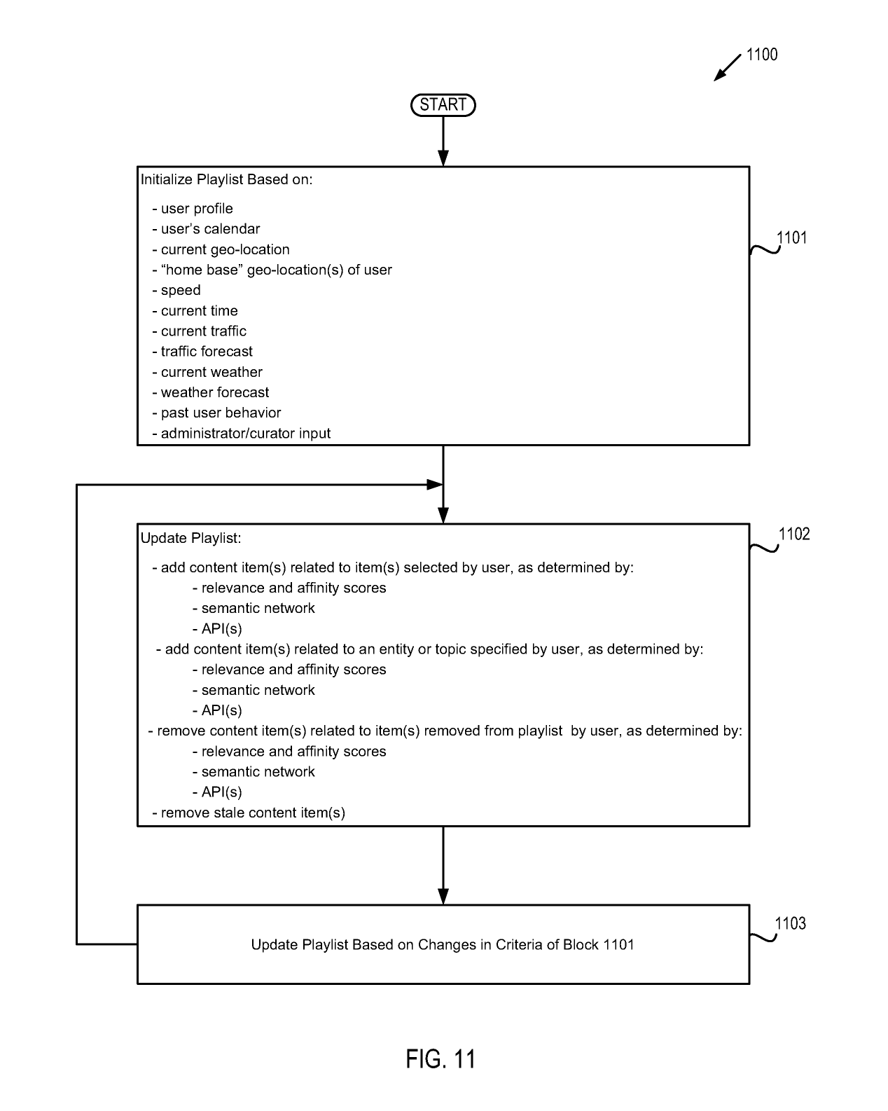

In accordance with some embodiments, playlist generator 130 is capable of generating and updating playlists for users of client machines 102-1 through 102-K, and of delivering the playlists to the client machines. An embodiment of a method by which playlist generator 130 may operate is described in detail below with respect to FIG. 11.

In accordance with some embodiments, action generator 135 is capable of generating possible actions for a user (e.g., buying a book on Amazon.com, making a reservation at a restaurant, sharing a content item via a social network such as Facebook, etc.) based on the user's selections from his or her playlist, or on an entity or topic of interest that the user has specified, or both. The operation of action generator 135 is described in detail below with respect to FIG. 12.

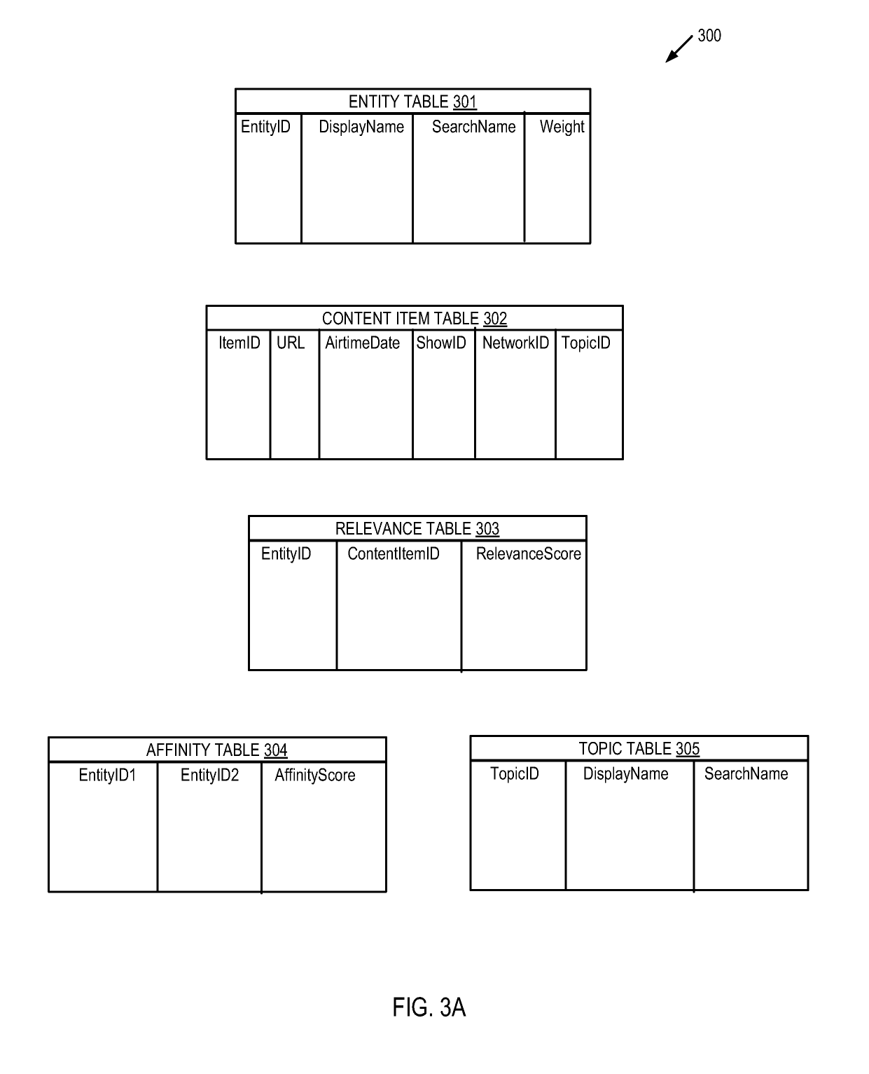

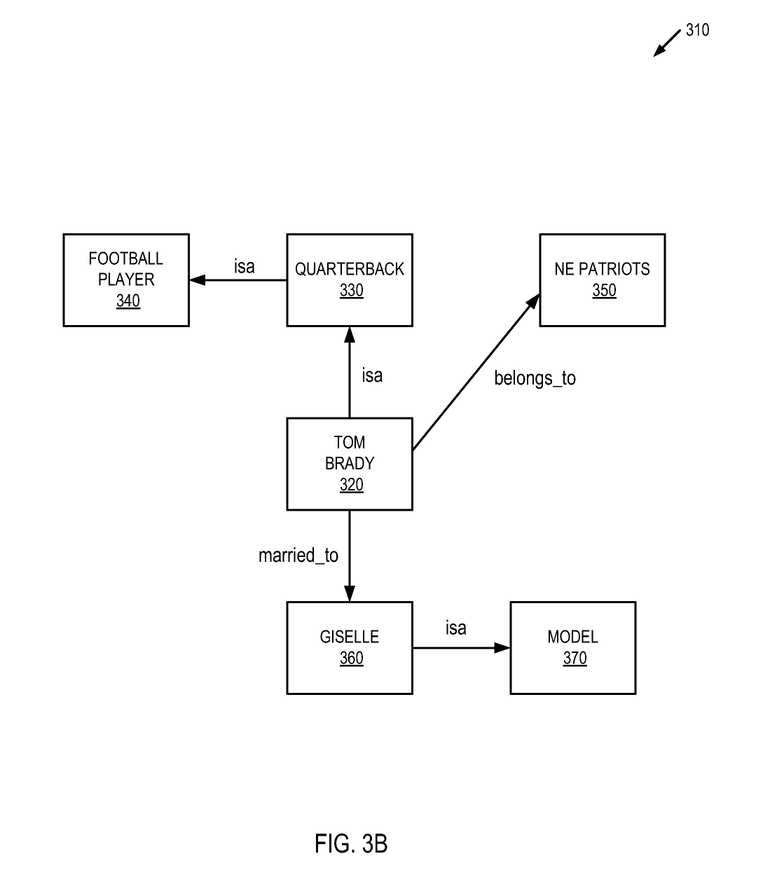

Content catalog 145 is a data store (e.g., a relational database, a file server, an object-oriented database, etc.) that stores information about content items in content repositories 110-1 through 110-N, such as uniform resource locators (URLs), topics and entities associated with the content items, and so forth. An illustrative data schema for content catalog 145 is described in detail below with respect to FIG. 3.

Text-to-speech (TTS) audio content data store 155 stores audio files corresponding to textual content items that have been converted to audio. In contrast to other content items, which are received by clients 102 from content repositories 110-1 through 110-N, clients 102 receive TTS audio content from data store 155, via server machine 115.

FIG. 2 is a block diagram of one embodiment of a content processing manager 200. The content processing manager 200 may be the same as the content processing manager 125 of FIG. 1 and may include an automated speech recognition (ASR)/text-to-speech (TTS) engine 201, a natural language processing (NLP) engine 202, a metadata gatherer 205, a text gatherer 206, an entity extractor 207, a relevance scorer 208, a pairwise affinity scorer 209, and a data store 210. It should be noted that in some embodiments, the components of content processing manager 200 may be combined together or separated into further components; moreover, the components of content processing manager 200 may run on a single machine (e.g., server machine 115, etc.) or may run on separate machines.

The data store 210 may be a permanent data store to hold metadata, text, content items, relevance and pairwise affinity scores, data structures for processing and organizing these data, and so forth. Alternatively, data store 210 may be hosted by one or more storage devices, such as main memory, magnetic or optical storage based disks, tapes or hard drives, NAS, SAN, and so forth.

The ASR/TTS engine 201 is software and/or hardware that generates text based on the audio portion of a content item. In one embodiment, the ASR/TTS engine 201 comprises Sphinx, an open source toolkit for speech recognition provided by Carnegie Mellon University, and the eSpeak open source speech synthesizer for English and other languages, made available by Sourceforge.Net.

The NLP engine 202 is software and/or hardware that parses text in a natural language (e.g., English, Spanish, etc.) and identifies grammatical constructs of the natural language such as noun groups, verb groups, and so forth. It should be noted that in some embodiments, NLP engine 202 may also be capable of performing other types of natural language processing functions (e.g., semantic interpretation, etc.). In one embodiment, NLP engine 202 is Natural Language ToolKit (NLTK), a suite of open source natural language tools in the Python programming language.

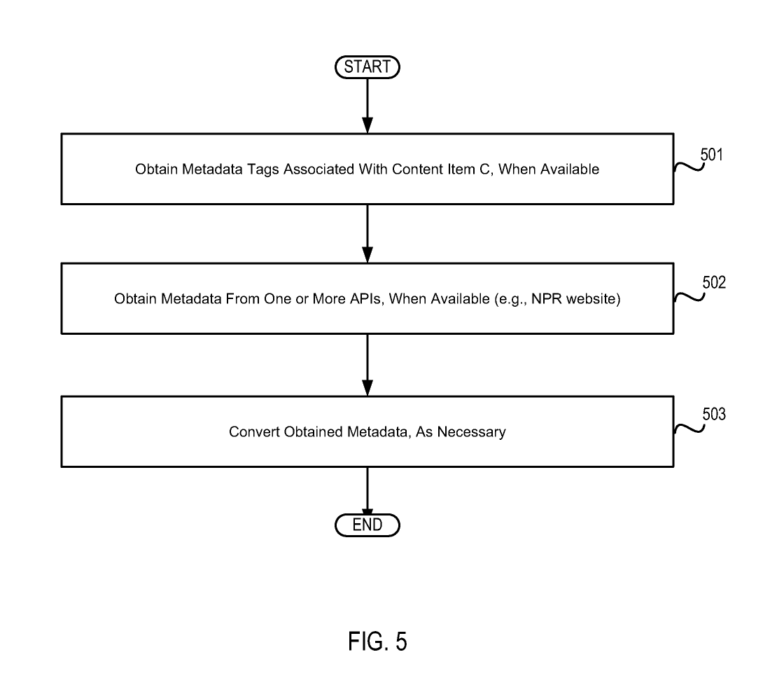

The metadata gatherer 205 is software and/or hardware that obtains metadata associated with a content item. Embodiments of the operation of metadata gatherer 205 are described in more detail below with respect to FIG. 5.

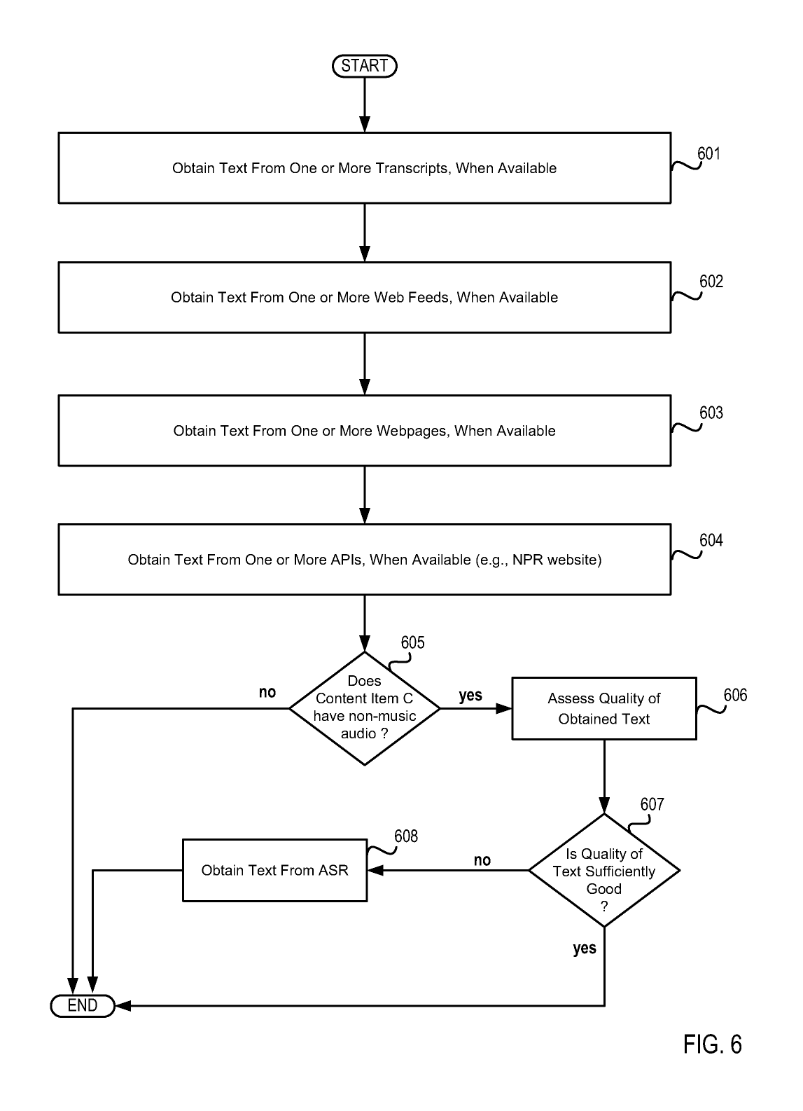

The text gatherer 206 is software and/or hardware that obtains text associated with a content item. Embodiments of the operation of text gatherer 206 are described in more detail below with respect to FIG. 6.

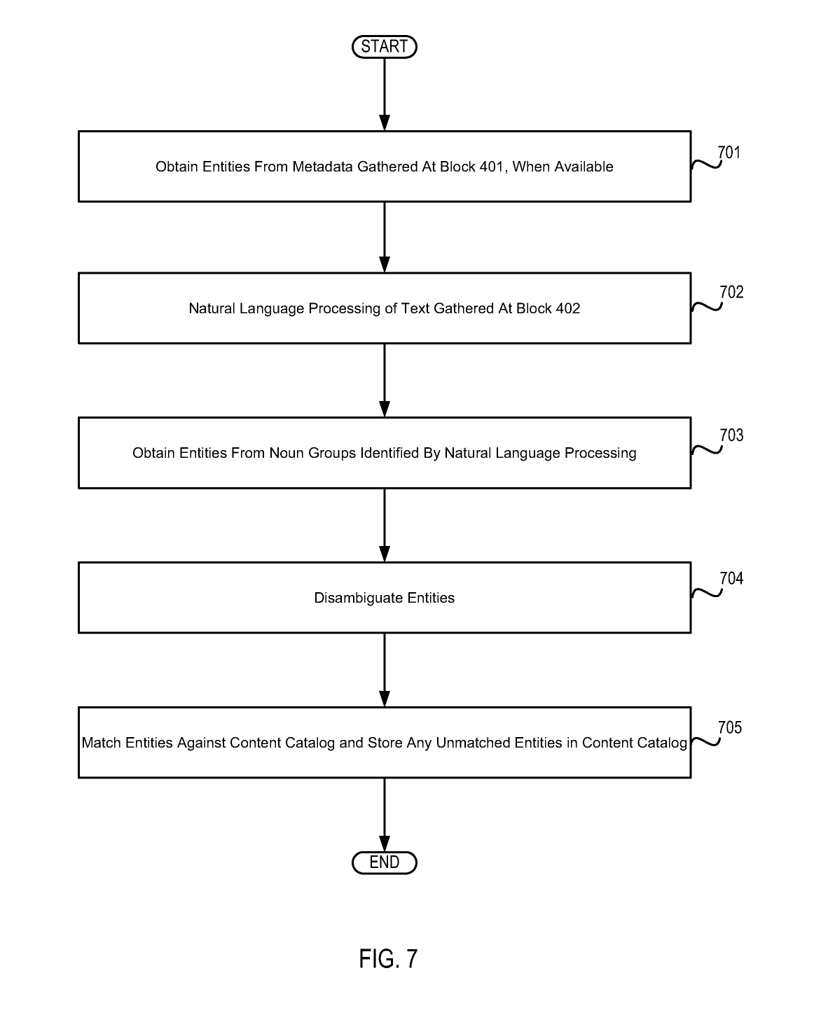

The entity extractor 207 is software and/or hardware that obtains a set of entities (e.g., proper nouns or noun groups) from metadata and text. Embodiments of the operation of entity extractor 207 are described in more detail below with respect to FIGS. 7 through 9.

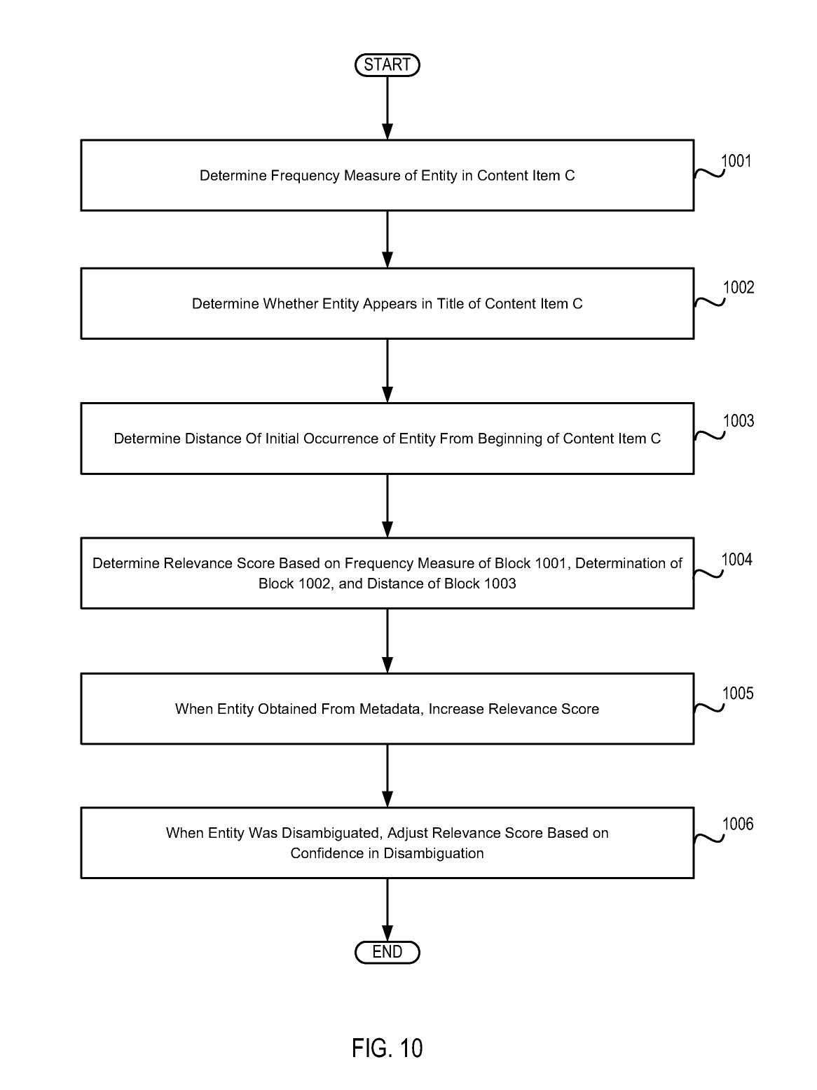

The relevance scorer 208 is software and/or hardware that determines a relevance score for an entity with respect to a particular content item. Embodiments of the operation of relevance scorer 208 are described in more detail below with respect to FIG. 10.

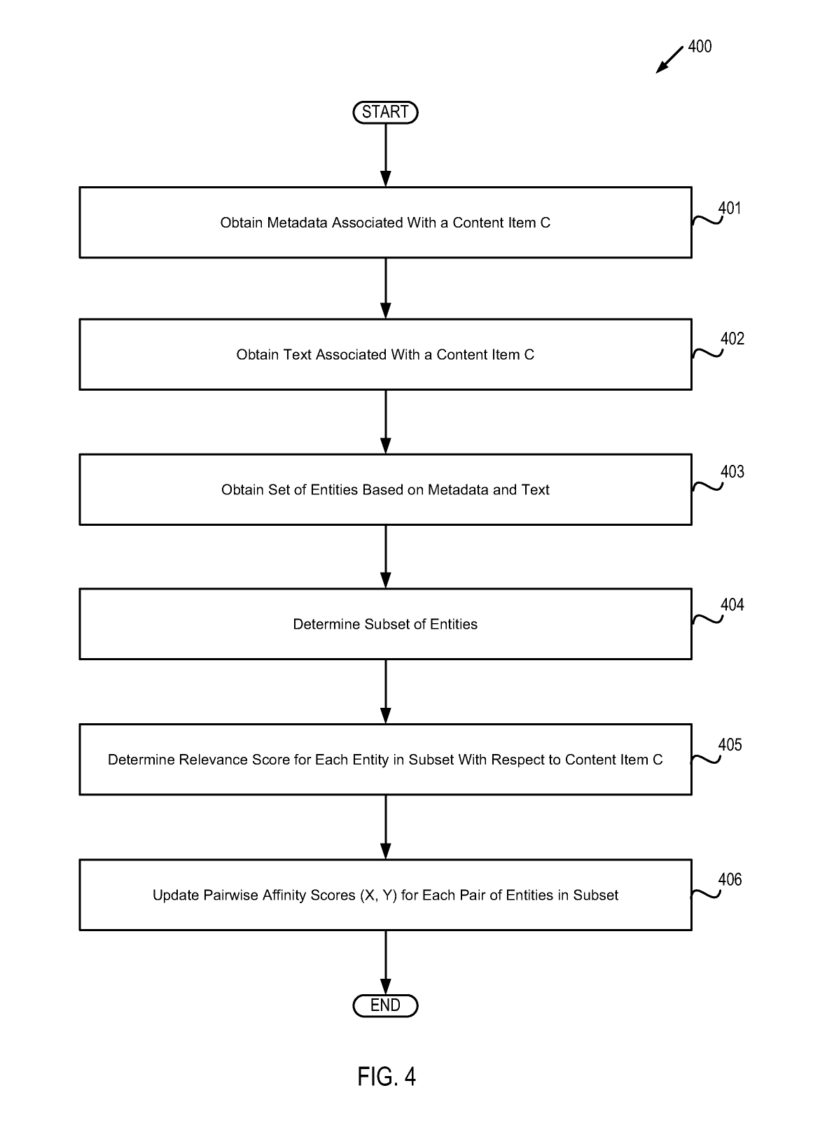

The pairwise affinity scorer 209 is software and/or hardware that updates an affinity score for a pair of entities, where the affinity score quantifies how closely correlated the two entities are (e.g., how frequently the two entities appear in the same content item, etc.). Embodiments of the operation of pairwise affinity scorer 209 is described in more detail below with respect to block 406 of FIG. 4.

FIG. 3A depicts an embodiment of a data schema 300 for a content catalog. It should be noted that for illustrative purposes, only the most salient aspects of the data schema is depicted in the figure. The data schema is represented as tables that are well-suited for storage in a relational database; however, it should be noted that in some other embodiments, the data may be represented in some other fashion (e.g., objects in an object-oriented database, text entries in a flat file, etc.).

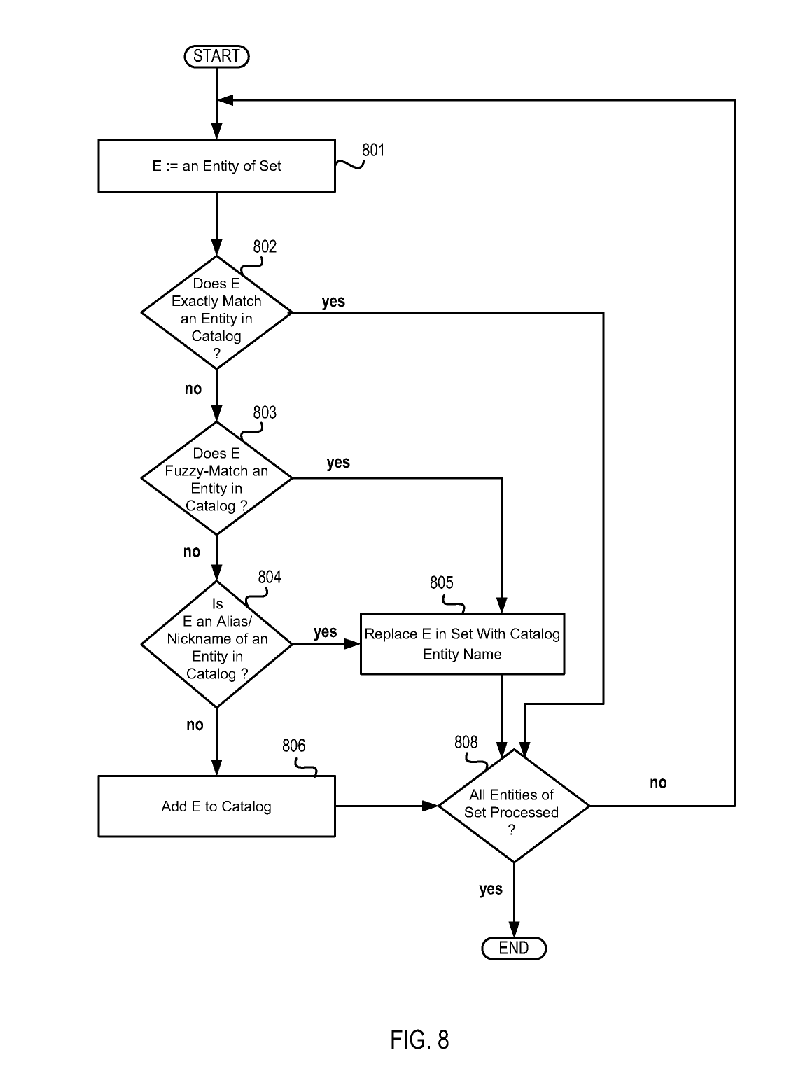

As shown in FIG. 3A, data schema 300 comprises an entity table 301, a content item table 302, a relevance table 303, an affinity table 304, and a topic table 305. Entity table 302 contains information pertaining to entities and comprises four columns: an EntityID that uniquely identifies an entity, a DisplayName that is a string for displaying the name of the entity, a SearchName that is a string for “fuzzy-matching” the entity (described in detail below with respect to the method of FIG. 8), and a Weight that is a measure of how common the entity is (e.g., a value in interval (0, Z] where Z is a positive real number that indicates a maximum in how often the entity appears in content items [e.g., entity “President Barack Obama”] and a very small value such as 0.002 indicates that the entity is uncommon [e.g., “Refsum's Disease”], etc.).

Content item table 302 contains information pertaining to content items and comprises six columns: an ItemID that uniquely identifies a content item, a URL (uniform resource locator) that indicates the Web address of the content item, an AirTimeDate that indicates when the content item was originally aired, a ShowID that uniquely identifies a show in which the content item was aired (e.g., NPR's All Things Considered, etc.), a NetworkID that uniquely identifies a particular network associated with the content item (e.g., NPR, CBS, etc.), and a TopicID that uniquely identifies a topic associated with the content item (e.g., book review, cinema, politics, sports, etc.).

Relevance table 303 associates entities with content items and comprises three columns: an EntityID that uniquely identifies an entity in table 301, a ContentItemID that uniquely identifies a content item in table 302, and a relevance score for the entity with respect to the content item (e.g., a value in interval [0, 1] where 1 indicates maximum relevance and zero indicates no relevance).

Affinity table 304 associates pairs of entities and comprises three columns: an EntityID1 that uniquely identifies a first entity in table 301, an EntityID2 that uniquely identifies a second entity in table 302, and an affinity score that indicates how strongly related the two entities are (e.g., a count of how many content items have been processed that contain both entities, a value in interval [0, 1] where 1 indicates maximum affinity and zero indicates no affinity, etc.). Topic table 305 comprises information pertaining to topics and comprises three columns: a TopicID that uniquely identifies a topic, a DisplayName that is a string for displaying the name of the topic, and a SearchName that is a string for “fuzzy-matching” the topic (described in more detail below with respect to the method of FIG. 8).

FIG. 3B depicts an illustrative portion 310 of a semantic network for a content catalog, in accordance with some embodiments. As shown in FIG. 3B, semantic network 310 comprises six nodes 320 through 370 that are related via labeled links, and represents the following information:
Tom Brady is a quarterback on the New England Patriots;
A quarterback is a football player; and
Tom Brady is married to Giselle, who is a model.
   As described in more detail below with respect to FIG. 11, the information stored in the semantic network can be used to determine what content items may be related to other content items (e.g., a news story about Tom Brady may be determined to be related to a news story about the New England Patriots, even if Tom Brady is not mentioned in the story about the Patriots).

FIG. 4 depicts a flow diagram of one embodiment of a method 400 for processing a content item C. The method is performed by processing logic that may comprise hardware (circuitry, dedicated logic, etc.), software (such as is run on a general purpose computer system or a dedicated machine), or a combination of both. In one embodiment, the method is performed by the server machine 115 of FIG. 1, while in some other embodiments, one or more of blocks 401 through 406 might be performed by another machine. It should be noted that blocks depicted in FIG. 4 may be performed simultaneously or in a different order than that depicted.

At block 401, metadata associated with a content item C is obtained. An embodiment of a method for performing block 401 is described in detail below with respect to FIG. 5. In one embodiment, block 401 is performed by metadata gatherer 205.

At block 402, text associated with a content item C is obtained. An embodiment of a method for performing block 402 is described in detail below with respect to FIG. 6. In one embodiment, block 402 is performed by text gatherer 206.

At block 403, a set of entities is obtained based on the metadata and text obtained at blocks 401 and 402. An embodiment of a method for performing block 403 is described in detail below with respect to FIG. 6. In one embodiment, block 403 is performed by entity extractor 207.

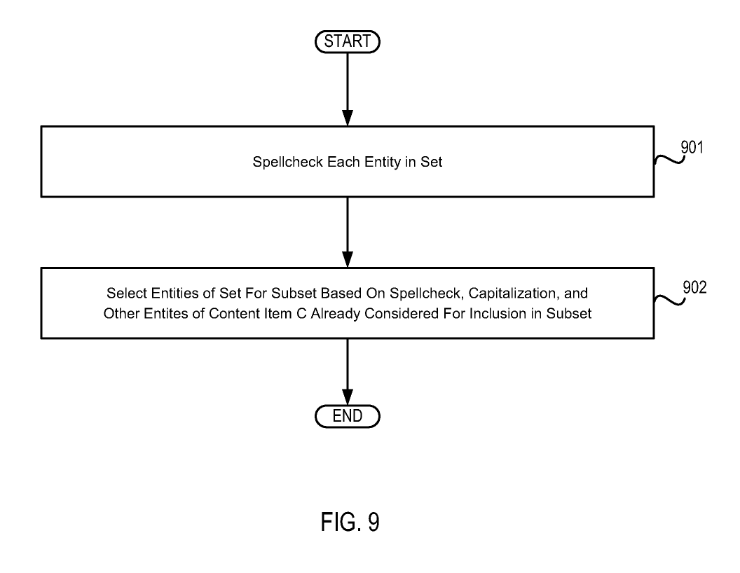

At block 404, a subset of the entities obtained at block 403 is determined. An embodiment of a method for performing block 404 is described in detail below with respect to FIG. 9. In one embodiment, block 404 is performed by entity extractor 207.

At block 405, a relevance score is determined for each entity of the subset determined at block 404 with respect to content item C. An embodiment of a method for performing block 405 is described in detail below with respect to FIG. 10. In one embodiment, block 404 is performed by relevance scorer 208.

At block 406, an affinity score for each pair of entities of the subset is updated. In one embodiment, the affinity score for each pair of entities is a counter that counts the number of times that the two entities have been extracted from the same content item, and this counter is incremented at block 406. It should be noted that in some other embodiments, some other type of pairwise affinity score might be employed, and, consequently, some other technique for updating the score might also be employed at block 406. In one embodiment, block 406 is performed by pairwise affinity scorer 209.

FIG. 5 depicts a flow diagram of one embodiment of a method for obtaining metadata associated with a content item C. It should be noted that blocks depicted in FIG. 5 may be performed simultaneously or in a different order than that depicted.

At block 501, metadata tags associated with content item C, when available, are retrieved from a content repository storing content item C. At block 502, metadata is obtained using one or more application programming interfaces (APIs), when available. For example, the provider of a content repository 110-j might also provide an API (e.g., via a Hypertext Transfer Protocol [http] web service, etc.) by which a program executing on another machine (e.g., server machine 115, etc.) can submit queries to obtain metadata associated with a content item residing in content repository 110-j.

At block 503, the metadata obtained at blocks 501 and 502 are converted, as necessary. For example, a topic specified by metadata might be semantically the same, but not exactly the same character string, as a topic in content catalog 145 (e.g., the metadata might be “movies” and the topic in content catalog 145 might be “cinema”). It should be noted that in some embodiments, the conversion may be performed using a table or mapping between topics, and may also based on the origin of the metadata (e.g., wsj.com, npr.org, etc.).

It should also be noted that some embodiments may omit one or more blocks of FIG. 5, or may skip one or more blocks based on the result of one or more prior blocks. For example, in some embodiments, when metadata tags are available at block 501, then block 502 may be skipped, the rationale being that metadata tags are typically more reliable sources of metadata than an application programming interface (API).

FIG. 6 depicts a flow diagram of one embodiment of a method for obtaining text associated with a content item C. It should be noted that blocks depicted in FIG. 6 may be performed simultaneously or in a different order than that depicted.

At block 601, text is obtained from one or more transcripts associated with content item C (e.g., a transcript of an audio interview provided by the provider of content item C, a transcript at a website unaffiliated with the provider of content item C, etc.), when available. At block 602, text is obtained from one or more web feeds (e.g., Real Simple Syndication [RSS] feeds, etc.) associated with content item C (e.g., an RSS feed provided by the provider of content item C, an RSS feed unaffiliated with the provider of content item C, etc.), when available.

At block 603, text is obtained from one or more webpages associated with content item C (e.g., a webpage comprising content item C, a webpage with a link to content item C, a webpage that has user comments pertaining to content item C, etc.), when available. At block 604, text is obtained using one or more application programming interfaces (APIs) associated with content item C (e.g., a web service API provided by the content repository at which content item C is stored, a web service API provided by a web server unaffiliated with the provider of the content repository, etc.), when available.

Block 605 branches based on whether content item C has non-music audio (e.g., human speech, etc.); if so execution continues at block 606, otherwise the method terminates.

At block 606, a measure of the quality of the text obtained at blocks 601 through 604 is determined. In one embodiment, the quality of text may be based on how the text was obtained (e.g., text from a transcript may be considered to be of higher quality than text from a webpage, etc.), as well as the origin of the text (e.g., an RSS feed from National Public Radio may be considered to be of higher quality than “Billy-Bob's RSS feed”). In some embodiments, the measure of the quality of text may be determined via rules coded by an expert, while in some other embodiments, the measure may be determined in some other fashion.

Block 607 checks whether the quality measure determined at block 606 exceeds a threshold (e.g., a threshold value that is set in a configuration file by an administrator, a threshold value that is hard-coded into content processing manager 200, etc.). If not, execution continues at block 608, otherwise the method terminates.

At block 608, text is obtained from the audio of content item C via automated speech recognition (ASR). In one embodiment, block 608 is performed by ASR engine 201.

It should also be noted that some embodiments may omit one or more blocks of FIG. 6, or may skip one or more blocks based on the result of one or more prior blocks. For example, in some embodiments, when text can be obtained from a transcript at block 601, then one or more of blocks 602, 603 and 604 may be skipped, the rationale being that text obtained from a transcript is typically of much higher quality than text obtained from other sources.

FIG. 7 depicts a flow diagram of one embodiment of a method for obtaining a set of entities associated with a content item C. It should be noted that blocks depicted in FIG. 7 may be performed simultaneously or in a different order than that depicted.

At block 701, entities are obtained from the metadata gathered at block 401 of FIG. 4, when such metadata is available. At block 702, natural language processing of the text gathered at block 402 of FIG. 4 is performed. In one embodiment, block 702 is performed by NLP engine 202.

At block 703, entities are obtained from the noun groups identified by the natural language processing of block 702. At block 704, entities obtained at block 703 are disambiguated, when necessary. In one embodiment, entities may be disambiguated based on the origin of content item C (e.g., if the entity “Eagles” is obtained from a content item from ESPN.com, then it may be reasonable to conclude that the entity more likely refers to the Philadelphia Eagles football team than the rock band The Eagles, etc.), or on other entities obtained from content item C (e.g., if the entities “Eagles” and “Grammy” are obtained from a content item, then it may be reasonable to conclude that the entity more likely refers to the rock band, etc.), or on a topic for the content item C (e.g., record review, politics, etc.).

It should be noted that in some embodiments, where content items are subsequently re-processed via the method of FIG. 4 after being added to users' playlists and selected by users, the disambiguation at block 703 may also be based on information associated with these users, such as their geo-location when selecting the content item (e.g., a user was in Philadelphia when playing a content item with the entity “Eagles”, etc.), demographic information (e.g., the user's age, sex, etc.), other content items selected by the user (e.g., a user has selected several content items related to football, etc.), and so forth.

At block 705, entities are matched against a content catalog (e.g., content catalog 145 of FIG. 1, etc.) and any unmatched entities are stored in the content catalog. An embodiment of a method for performing block 705 is described in detail below with respect to FIG. 8.

FIG. 8 depicts a flow diagram of one embodiment of a method for matching a set of entities against a content catalog. It should be noted that blocks depicted in FIG. 8 may be performed simultaneously or in a different order than that depicted.

At block 801, an entity E is selected from the set. Block 802 checks whether entity E exactly matches an entity in the content catalog; if so, execution continues at block 808, otherwise execution proceeds to block 803.

Block 803 checks whether entity E “fuzzy-matches” an entity in the content catalog (e.g., stem matching, word order matching, phonetic matching, alternative or misspellings, etc.); if so, execution continues at block 805, otherwise execution proceeds to block 804. Block 804 checks whether entity E is an alias or a nickname of an entity in the content catalog (e.g., “J-Lo” is a nickname for “Jennifer Lopez”); if so, execution proceeds to block 805, otherwise execution continues to block 806.

At block 805, entity E is replaced in the set of entities with the entity in the content catalog. At block 806, entity E is added to the content catalog.

Block 808 checks whether all entities of the set have been processed; if not, execution continues back at block 801, where another entity of the set is selected and another iteration of the method is performed.

FIG. 9 depicts a flow diagram of one embodiment of a method for obtaining a subset of a set of entities associated with a content item. It should be noted that blocks depicted in FIG. 9 may be performed simultaneously or in a different order than that depicted.

At block 901, each entity in the set of entities is spellchecked. At block 902, entities of the set are selected for inclusion in the subset of entities based on: the results of the spellcheck of block 901, capitalization of the entities, and other entities in the set that have already been considered for inclusion in the subset. For example, in some embodiments, when an entity is recognized by the spellchecker as a normal natural language phrase, then the entity is not considered a proper name (and thus not included in the subset) unless the entity is capitalized. As another example, in some embodiments, if the entity “Biden” is being considered for inclusion in the subset at block 902 and the entity “Joe Biden” has already been included in the subset, then the redundant entity “Biden” is not included in the subset.

FIG. 10 depicts a flow diagram of one embodiment of a method for determining a relevance score for an entity with respect to a content item C. It should be noted that blocks depicted in FIG. 10 may be performed simultaneously or in a different order than that depicted.

At block 1001, a frequency measure of the entity in content item C (e.g., how many instances of the entity are in content item C, etc.) is determined. Block 1002 determines whether the entity appears in the title of the content item C, and block 1003 determines a distance (e.g., the number of words, the number of characters, the number of paragraphs, etc.) between the first occurrence of the entity in content item C and the beginning of content item C.

At block 1004, a relevance score is determined based on the frequency measure obtained in block 1001, the determination of block 1002, and the distance obtained in block 1003. In one embodiment, these data are combined by the formula:

R=F+aD+bT

where R is the relevance score, F is the raw frequency measure, D is a normalized distance of the first occurrence from the beginning of content item C (e.g., 0.2 would mean that the entity first occurs 20% into the article, etc.), a and b are selected constants, and T is a Boolean value that equals 1 when the entity is in the title of content item C, and zero otherwise.

At block 1005, when the entity was obtained from metadata, the relevance score determined at block 1004 is increased by a value Δ, up to a maximum possible score. In one embodiment, the value of Δ may be based on the source of the metadata (e.g., the value of Δ for metadata from WSJ.com might be greater than the value of Δ for metadata from PodunkGazette.com). It should be noted that in some other embodiments, an entity that is obtained from metadata might automatically be promoted to the top of a list of entities for content item C, thereby corresponding, in effect, to a maximum possible score

At block 1006, when the entity was obtained via disambiguation, the relevance score is adjusted based on a confidence in the disambiguation. For example, for some content items there might be a high level of confidence in interpreting the entity “Francis Bacon” as the 20^{th} century artist (versus, among others, the English Elizabethan essayist), while in other content items the level of confidence might be lower (say, in a content item about notable men in British history).

FIG. 11 depicts a flow diagram of one embodiment of a method for generating and updating a playlist. In one embodiment, the method of FIG. 11 is performed by playlist generator 130 of server machine 115. It should be noted that although in one embodiment the playlist items comprise URLs at which the content items are located, titles of the content items, and so forth, rather than the content items themselves, for convenience the inventors refer to a content item being “in the playlist”, even though the content items are stored remotely. It should also be noted that blocks depicted in FIG. 11 may be performed simultaneously or in a different order than that depicted.

At block 1101, a playlist is initialized based on one or more of the following:
a user profile (e.g., a profile that a user chooses from a set of possible profiles, a profile that a user builds from scratch, a profile that is instantiated with a user's answers to questions such as “What is your favorite genre of music?”, etc.);
a user's calendar or schedule that stores meetings, appointments, travel plans, etc.;
a user's current geo-location (as inferred from the user's client device);
one or more “home base” geo-locations of a user (e.g., a user who has an apartment in New York and a house in Los Angeles would have two such home base geo-locations);
a user's current speed (as inferred from the user's client device);
the current time at the user's geo-location;
the current traffic in the vicinity of the user's geo-location;
a traffic forecast for the user's geo-location;
the current weather at the user's geo-location;
a weather forecast for the user's geo-location;
past user behavior (e.g., previous content item selections, historical driving information, past entries in a calendar or schedule, etc.); and
input from an administrator or curator.

The above criteria can be used to generate a playlist in intelligent fashion in a variety of ways; for example:
a playlist for a teenaged girl might contain a Justin Bieber song, a news story about Kim Kardashian, etc.;
a playlist for a user who indicates his favorite type of music is classical music might contain a story about an upcoming opera production, an audio clip that is the first movement of a new recording of Beethoven's fourth symphony, etc.;
a playlist for a user whose calendar indicates that he is in transit to a baseball game might contain a story about the local baseball team, etc.;
a playlist for a user whose home base is New York and is currently in Texas might contain a song that is related to Texas (e.g., “Texas Flood” by Stevie Ray Vaughn, a song by the guitarist Eric Johnson, who is a Texan, etc.), an article that is related to Texas (e.g., about the Alamo, etc.), a restaurant review for a nearby barbeque-style restaurant, and so forth;
a playlist for a user who is traveling fast might contain rock music tracks, as opposed to quiet chamber music tracks;
at 1:00 am a playlist for a user whose profile indicates that she likes rock music and jazz might contain jazz tracks and softer rock tracks (e.g., “Yesterday” by the Beatles, etc.);
a playlist for a user who is in heavy traffic might contain a story about local highway construction, or a soothing music track, etc;
a playlist for a user who is experiencing great weather might contain the Beatles track “Good Day Sunshine”, an article about sunscreen lotion, etc.;
a playlist for a user who has previously selected a lot of Beatles songs from the playlist might contain some songs from The Who, etc.;
when a user's calendar indicates that the user attended the musical “American Idiot” last night, the playlist might contain tracks from the band Green Day, an article about the making of the musical, etc.; and
a playlist might contain items selected as noteworthy or timely by a human administrator or curator.

At block 1102, the playlist is updated via one or more of the following:
one or more content items that are related to one or more items selected by the user may be added to the playlist, where related items are determined based on: the relevance and affinity scores in content catalog 145, a semantic network stored in content catalog 145, one or more application programming interfaces (APIs) (e.g., an iTunes API that identifies tracks related to another track, an Amazon.com API that identifies books associated with Abraham Lincoln, etc.), or some combination thereof;
one or more content items that are related to one or more entities or topics specified by the user may be added to the playlist, where related items are determined based on the relevance and affinity scores, the semantic network, one or more APIs, or some combination thereof;
one or more content items that are related to one or more items removed from the playlist by the user may also be removed from the playlist, where related items are determined based on the relevance and affinity scores, the semantic network, one or more APIs, or some combination thereof; or
one or more “stale” content items might be removed from the playlist (e.g., an outdated traffic report, etc.).

At block 1103, the playlist is updated once again, when applicable, based on a change in one or more of the criteria of block 1101 (e.g., a user who was in San Francisco is now in San Jose, a change in weather or traffic, etc.). After block 1103, execution continues back at 1102, so that the playlist is periodically updated in accordance with the techniques of blocks 1102 and 1103.

FIG. 12 depicts a flow diagram of one embodiment of a method for presenting a playlist to a user and processing user input. In one embodiment, the method of FIG. 12 is performed by client application 103-j, where j is an integer between 1 and K inclusive. It should be noted that, as in FIG. 11, content items are referred to as being in the playlist, despite the fact that in one embodiment the content items are stored remotely. It should also be noted that blocks depicted in FIG. 12 may be performed simultaneously or in a different order than that depicted.

At block 1201, one or more playlist content items are received from server machine 115. In one embodiment, the playlist content items are received from playlist generator 130.

At block 1202, the playlist is presented (e.g., output to a display of a client machine, output in audio form to a speaker of a client machine, etc.) to a user. At block 1203, input is received from the user. This input may be the selection of a content item from the playlist, the specification of an entity or topic of interest, and so forth, and may be provided via a touchscreen of a client machine, via a microphone of a client machine, etc.

At block 1204, the user input is processed. In one embodiment, processing of user input comprises:
converting speech input to text, when applicable (e.g., by an ASR engine resident on the client machine, by transmitting the speech signals to server machine 115 for conversion by ASR/TTS engine 201, etc.);
when the user input is the selection of a content item from the playlist, transmitting a request for the content item over network 104 to the appropriate content repository 110 (or server machine 115, when the content item is TTS audio in data store 155);
when the user input is an entity or topic of interest, transmitting a request to server machine 155 for related content item links; and
when the user input is in response to a suggested action (e.g., purchasing a book, etc.), transmitting to server machine 115 a message that indicates accordingly whether or not to perform the action.

At block 1205, one or more possible user actions are received. In one embodiment, the possible user actions are determined by action generator 135 of server machine 115, and may be based on a variety of factors such as a content item selected by the user at block 1204, an entity or topic specified by the user at block 1204, the geo-location of the user, and so forth. For example, when a user has selected an interview with the author Stephen King about his latest book, the user might receive a suggested action to purchase the book at Amazon.com. As another example, when a user has selected a review about a new movie, the user might receive a suggested action to purchase a ticket for the movie at a local cinema. As another example, when the user input is the selection of a story about a new Italian cooking program on the Food Channel, the user might receive a suggested action to make a reservation at a nearby highly-rated Italian restaurant. As yet another example, when user input indicates that the user has enjoyed a content item, the user may receive a suggested action to share the content item with friends in his or her social network.

At block 1206, the one or more possible actions received at block 1205 are presented to the user (e.g., displayed, output in audio form, etc.). After block 1206, execution continues back at block 1201.

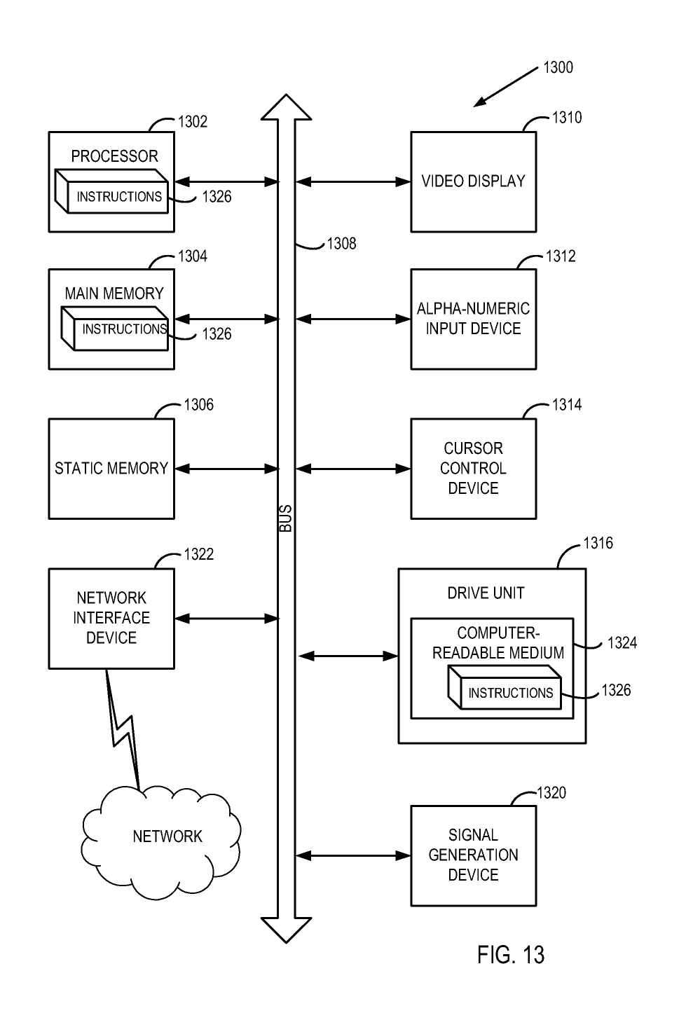

FIG. 13 illustrates an exemplary computer system within which a set of instructions, for causing the machine to perform any one or more of the methodologies discussed herein, may be executed. In alternative embodiments, the machine may be connected (e.g., networked) to other machines in a LAN, an intranet, an extranet, or the Internet. The machine may operate in the capacity of a server machine in client-server network environment. The machine may be a personal computer (PC), a set-top box (STB), a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 1300 includes a processing system (processor) 1302, a main memory 1304 (e.g., read-only memory (ROM), flash memory, dynamic random access memory (DRAM) such as synchronous DRAM (SDRAM)), a static memory 1306 (e.g., flash memory, static random access memory (SRAM)), and a data storage device 1316, which communicate with each other via a bus 1308.

Processor 1302 represents one or more general-purpose processing devices such as a microprocessor, central processing unit, or the like. More particularly, the processor 1302 may be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 1302 may also be one or more special-purpose processing devices such as an application specific integrated circuit (ASIC), a field programmable gate array (FPGA), a digital signal processor (DSP), network processor, or the like. The processor 1302 is configured to execute instructions 1326 for performing the operations and steps discussed herein.

The computer system 1300 may further include a network interface device 1322. The computer system 1300 also may include a video display unit 1310 (e.g., a liquid crystal display (LCD) or a cathode ray tube (CRT)), an alphanumeric input device 1312 (e.g., a keyboard), a cursor control device 1314 (e.g., a mouse), and a signal generation device 1320 (e.g., a speaker).

The data storage device 1316 may include a computer-readable medium 1324 on which is stored one or more sets of instructions 1326 (e.g., instructions executed by content processing manager 125 and corresponding to blocks 301 through 304 of FIG. 3, etc.) embodying any one or more of the methodologies or functions described herein. Instructions 1326 may also reside, completely or at least partially, within the main memory 1304 and/or within the processor 1302 during execution thereof by the computer system 1300, the main memory 1304 and the processor 1302 also constituting computer-readable media. Instructions 1326 may further be transmitted or received over a network via the network interface device 1322.

While the computer-readable storage medium 1324 is shown in an exemplary embodiment to be a single medium, the term “computer-readable storage medium” should be taken to include a single medium or multiple media (e.g., a centralized or distributed database, and/or associated caches and servers) that store the one or more sets of instructions. The term “computer-readable storage medium” shall also be taken to include any medium that is capable of storing, encoding or carrying a set of instructions for execution by the machine and that cause the machine to perform any one or more of the methodologies of the present disclosure. The term “computer-readable storage medium” shall accordingly be taken to include, but not be limited to, solid-state memories, optical media, and magnetic media.

In the above description, numerous details are set forth. It will be apparent, however, to one of ordinary skill in the art having the benefit of this disclosure, that embodiments of the disclosure may be practiced without these specific details. In some instances, well-known structures and devices are shown in block diagram form, rather than in detail, in order to avoid obscuring the description.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the above discussion, it is appreciated that throughout the description, discussions utilizing terms such as “receiving,” “determining,” “obtaining,” “storing,” or the like, refer to the actions and processes of a computer system, or similar electronic computing device, that manipulates and transforms data represented as physical (e.g., electronic) quantities within the computer system's registers and memories into other data similarly represented as physical quantities within the computer system memories or registers or other such information storage, transmission or display devices.

Embodiments of the disclosure also relate to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

The algorithms and displays presented herein are not inherently related to any particular computer or other apparatus. Various general purpose systems may be used with programs in accordance with the teachings herein, or it may prove convenient to construct a more specialized apparatus to perform the required method steps. The required structure for a variety of these systems will appear from the description below. In addition, the present disclosure is not described with reference to any particular programming language. It will be appreciated that a variety of programming languages may be used to implement the teachings of the disclosure as described herein.

It is to be understood that the above description is intended to be illustrative, and not restrictive. Many other embodiments will be apparent to those of skill in the art upon reading and understanding the above description. Moreover, the techniques described above could be applied to other types of data instead of, or in addition to, video clips (e.g., images, audio clips, textual documents, web pages, etc.). The scope of the invention should, therefore, be determined with reference to the appended claims, along with the full scope of equivalents to which such claims are entitled.

What is claimed is:

1. A method comprising:
obtaining, by a computer system, text associated with a content item, wherein the text associated with the content item comprises:
text from a transcript associated with a content item, when available,
text from a web feed associated with the content item, when available,
text from a webpage associated with the content item, when available, and
text that is returned from a call to an application programming interface of a provider of the content item, when available; and
determining by the computer system, based on the text associated with the content item, a set of entities associated with the content item.

2. The method of claim 1 wherein the content item comprises audio, the method further comprising:
determining a quality measure for the text associated with the content item; and
when the quality measure is below a threshold, obtaining text from the audio via automated speech recognition.

3. The method of claim 1 wherein the obtaining of the set of entities associated with the content item comprises natural language processing of the text associated with the content item.

4. The method of claim 3 wherein each of the entities corresponds to a respective noun group identified by the natural language processing.

5. The method of claim 1 further comprising determining, by the computer system, a subset of the set of entities based on a spellcheck of the set of entities and a capitalization check of the set of entities.

6. The method of claim 5 wherein the determining of the subset comprises:
determining whether a first entity of the set of entities is included in the subset; and
determining whether a second entity of the set of entities is included in the subset based, at least in part, on whether the first entity is included in the subset.

7. The method of claim 5 further wherein the determining of the subset comprises disambiguating a first entity of the set of entities based on one or more of: the origin of a content item, a geo-location, or a second entity of the set of entities.

8. The method of claim 5 further comprising:
determining, by the computer system, whether a data store has an entity that matches an entity of the subset; and
storing in the data store, by the computer system, the entity of the subset when no match is found.

9. The method of claim 1 further comprising:
determining, by the computer system, whether a data store has an entity that matches an entity E; and
replacing entity E with an entity in the data store that matches, but does not exactly match, entity E.

10. An apparatus comprising:
a network interface; and
a processor to:
select a content item for inclusion in a playlist associated with a user, wherein the selection is based on the current geo-location of a client device associated with the user and a home geo-location associated with the user; and
transmit to the client device, via the network interface, a link to the content item.

11. The apparatus of claim 10 wherein the selection is also based on the current time at the client device.

12. The apparatus of claim 10 wherein the selection is also based on the current weather at the client device.

13. The apparatus of claim 10 wherein the selection is also based on a traffic report for a region comprising the current geo-location of the client device.

14. The apparatus of claim 10 wherein the selection is also based on prior user selections from the playlist.

15. The apparatus of claim 10 wherein the selection is also based on the origin of a content item selected by the user.

16. The apparatus of claim 10 wherein the selection is also based on a schedule associated with the user.

17. A method comprising:
determining, by a computer system, a relevance score for an entity with respect to a content item, wherein the relevance score is based, at least in part, on whether or not the entity was obtained from metadata associated with the content item; and
storing, by the computer system, a record that associates the entity, the content item, and the relevance score.

18. The method of claim 17 wherein the entity is obtained from at least one of: metadata associated with the entity, a transcript associated with the entity, a web feed associated with the entity, a webpage associated with the entity, or an application program interface of a provider of the content item.

19. The method of claim 17 wherein the entity was obtained via disambiguation, and wherein the relevance score is also based on a confidence in the disambiguation.

20. The method of claim 17 wherein the determining of the relevance score is also based on a distance of an initial occurrence of the entity from the beginning of the content item.
